(19) United States
(12) Patent Application Publication
(10) Pub. No.: US 2023/0017717 A1
(43) Pub. Date: Jan. 19, 2023

(54) DECENTRALIZED CONTENT DISTRIBUTION IN A COMPUTING SYSTEM

(71) Applicant: AMADEUS S.A.S., Biot (FR)

(72) Inventors: Rodolphe TEXIER, Vallauris (FR); Herve PREZET, Mougins (FR); Massimiliano MAINI, Biot (FR)

(21) Appl. No.: 17/867,070

(22) Filed: Jul. 18, 2022

Related U.S. Application Data
(60) Provisional application No. 63/223,144, filed on Jul. 19, 2021.

(51) Int. Cl. G06Q 30/06; G06Q 10/02

(52) U.S. Cl. CPC G06Q 30/0641; G06Q 10/02

(57) ABSTRACT

A method includes: receiving, at a computing device implementing a first node of a plurality of nodes forming a decentralized content distribution system, an inbound content request from an entry one of the nodes, the inbound content request including inbound search parameters derived from a client request received at the entry node; selecting, at the computing device, based on the inbound content request and a set of node profiles corresponding to the plurality of nodes, a further one of the nodes; transmitting an outbound content request to the selected further node, the outbound content request containing outbound search parameters based on the inbound search parameters; receiving, from the further node, subsidiary content corresponding to the outbound search parameters; and generating and transmitting, to the entry node, a response to the inbound content request, the response including an offer identifier and at least a portion of the subsidiary content.

### CROSS-REFERENCE TO RELATED APPLICATIONS

This application claims priority to U.S. Provisional Application No. 63/223,144, filed Jul. 19, 2021, the contents of which is incorporated herein by reference.

### FIELD

The specification relates generally to computing methods and systems, and specifically to methods and systems for decentralized content distribution.

### BACKGROUND

Certain types of items, such as travel-related goods or services (e.g., flight tickets, hotel reservations, vehicle rentals, or the like), may be supplied by a wide variety of distinct entities, such as airlines, hotel operators, vehicle rental agencies, and so on (broadly referred to as suppliers). The process of searching for (also referred to as shopping) and purchasing such items is often performed via interactions with various computing systems, and may be mediated by computing subsystems implementing aggregators, search providers, and the like (broadly referred to as gatekeeping subsystems). The number of gatekeeping subsystems may be relatively small in comparison to the number of suppliers, and because client subsystems such as consumers, travel agencies and the like may interact primarily with the gatekeeping subsystems rather than directly with the suppliers, the gatekeeping subsystems may exercise considerable, and sometimes undesirable, control over order flow to suppliers.

### SUMMARY

An aspect of the specification provides a method including: receiving, at a computing device implementing a first node of a plurality of nodes forming a decentralized content distribution system, an inbound content request from an entry one of the nodes, the inbound content request including inbound search parameters derived from a client request received at the entry node; selecting, at the computing device, based on the inbound content request and a set of node profiles corresponding to the plurality of nodes, a further one of the nodes; transmitting an outbound content request to the selected further node, the outbound content request containing outbound search parameters based on the inbound search parameters; receiving, from the further node, subsidiary content corresponding to the outbound search parameters; and generating and transmitting, to the entry node, a response to the inbound content request, the response including an offer identifier and at least a portion of the subsidiary content.

Another aspect of the specification provides a computing device implementing a first node of a plurality of nodes forming a decentralized content distribution system, comprising; a memory; a communications interface; and a processor configured to: receive an inbound content request from an entry one of the nodes, the inbound content request including inbound search parameters derived from a client request received at the entry node; select based on the inbound content request and a set of node profiles corresponding to the plurality of nodes, a further one of the nodes; transmit an outbound content request to the selected further node, the outbound content request containing outbound search parameters based on the inbound search parameters; receive, from the further node, subsidiary content corresponding to the outbound search parameters; and generate and transmitting, to the entry node, a response to the inbound content request, the response including an offer identifier and at least a portion of the subsidiary content.

### BRIEF DESCRIPTIONS OF THE DRAWINGS

Embodiments are described with reference to the following figures.

FIG. 1 is a diagram of a content distribution system.

FIG. 2 is a diagram of a decentralized content distribution system.

FIG. 3 is a diagram of certain internal components of a node in the decentralized content distribution system of FIG. 2.

FIG. 4 is a flowchart of a method for decentralized content distribution.

FIG. 5 is a diagram illustrating an example performance of blocks 405 to 415 of the method of FIG. 4.

FIG. 6 is a diagram illustrating an example performance of blocks 425 and 430 of the method of FIG. 4.

FIG. 7 is a diagram illustrating an example performance of blocks 435 and 440 of the method of FIG. 4.

FIG. 8 is a diagram illustrating an example performance of blocks 445 and 455 of the method of FIG. 4.

FIG. 9 is a diagram illustrating another example performance of block 445 of the method of FIG. 4.

### DETAILED DESCRIPTION

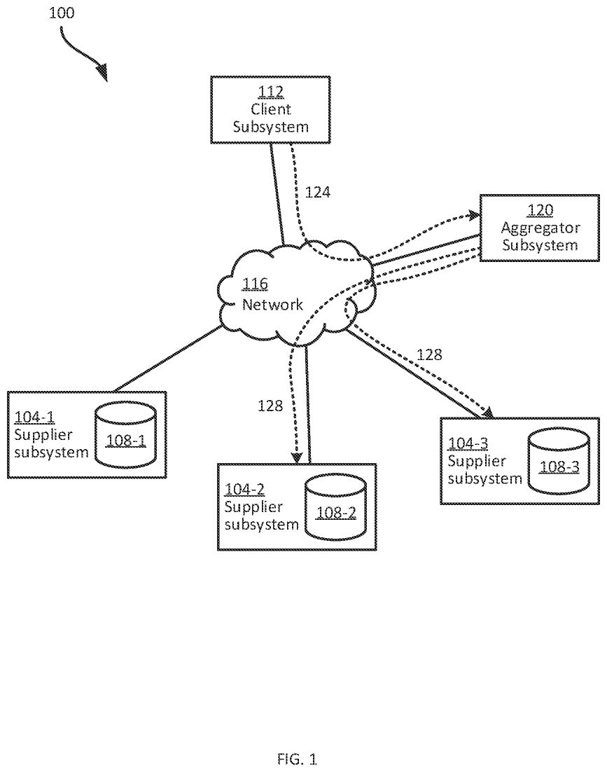

FIG. 1 illustrates a content distribution system 100. The term “content”, as used herein, refers to data defining a wide variety of items supplied to end users (e.g., individual consumers, such as travelers). Examples of such items include travel-related goods and services, such as flight tickets, hotel reservations, vehicle rentals and the like. Examples of content therefore include data defining those items, e.g., data defining the origin and departure locations, as well as departure and arrival times, for a flight. Such content can also define pricing information, and various other data used to implement the physical provision of such items. The specific nature of the items, and therefore of the content, is not particularly limited, however. Travel-related goods and services are referred to herein for illustrative purposes, but the functionality described below can also be applied to other forms of content, i.e., defining other forms of items.

As will be evident, the provision of the items mentioned above by supplier entities (e.g., airlines, hotel operators, vehicle rental agencies, etc.) to client entities is generally initiated by the exchange of the above-mentioned content between computing subsystems operated by or on behalf of the suppliers, and computing subsystems operated by or on behalf of the clients. For example, a client subsystem may search for items meeting arbitrary criteria (e.g., flights between specific cities on a certain date, or range of dates), and one or more supplier subsystems may return content matching, to at least some degree, the search criteria. The client subsystem may then, for example, select at least a portion of that content (e.g., representing one particular item, or a set of items) to initiate a purchase of the corresponding item(s).

Some systems implement intermediate entities between the client subsystems and supplier subsystems mentioned above. Referring to FIG. 1, for example, a system 100 is illustrated that includes a plurality of supplier subsystems 104-1, 104-2, 104-3 (collectively referred to as supplier subsystems 104, and generically referred to as a supplier subsystem 104; similar nomenclature is used for other components discussed herein). The supplier subsystems 104 are implemented as computing devices, e.g., operated by or on behalf of corresponding supplier entities. Each supplier subsystem maintains an inventory of items, e.g., in the form of respective repositories 108-1, 108-2, and 108-3. The system 100 also includes a client subsystem 112, such as a computing device operated by a travel agent, individual traveler, or the like. As will be apparent, the system 100 can include greater numbers of supplier subsystems 104 and client subsystems 112 in other embodiments.

Each of the supplier subsystems 104 and the client subsystem 112 are in communication with a network 116, e.g., any suitable combination of local and wide-area networks. However, the client subsystem 112 does not necessarily communicate directly with the supplier subsystems 104 over the network 116. Instead, in this implementation, the client subsystem 112 communicates directly with an aggregator subsystem 120. The aggregator subsystem 120, generally operated by an entity distinct from the supplier entities, receives client requests including search parameters (e.g., the above-mentioned criteria for a flight). FIG. 1 illustrates an example request 124 from the client subsystem 112 to the aggregator subsystem 120. The aggregator subsystem 120, in turn, selects one or more of the supplier subsystems 104, and forwards requests 128 containing the above search parameters to the selected supplier subsystems 104. The supplier subsystems 104-2 and 104-3, in the illustrated example, return relevant content to the aggregator 120, which evaluates such content and returns some portion of that content to the client subsystem 112.

The distribution of content as outlined in connection with FIG. 1 thus relieves the client subsystem 112 of contacting multiple supplier subsystems 104 independently, which may involve implementing various different messaging syntaxes, separate message flows, and the like. Similarly, the aggregator subsystem 120 may reduce the burden of supporting various distinct client applications by the supplier subsystems 104. However, intermediation of content distribution by the aggregator subsystem 120 in FIG. 1 also positions the aggregator subsystem 120 as a gatekeeper, with the effect that the supplier subsystems 104 and the client subsystem 112 may have little control over which content is actually made available from the supplier subsystems 104 to the client subsystem 112.

Reducing the influence of the aggregator subsystem 120 may therefore be desirable from a commercial perspective. From a technical perspective, however, reducing the reliance of the content distribution system on the aggregator subsystem presents several challenges.

For example, some systems may reduce the influence of gatekeeper entities such as the aggregator subsystem 120, meta-search providers, and the like, by configuring client subsystems 112 to contact each supplier subsystem 104 directly. As noted above, however, direct contact between a client subsystem 112 and multiple supplier subsystems 104, e.g., particularly to obtain content for a multi-item travel itinerary or the like, may impose a substantial technical burden on the client subsystem 112. Such an arrangement may also negatively impact the discoverability of supplier subsystems 104. That is, if the client subsystem 112 is required to contact individual supplier subsystems 104 directly, the distribution of content within the system 100 may become dependent on whether the particular client subsystem 112, or even whether a particular operator of that client subsystem 112, is aware of particular supplier subsystems 104.

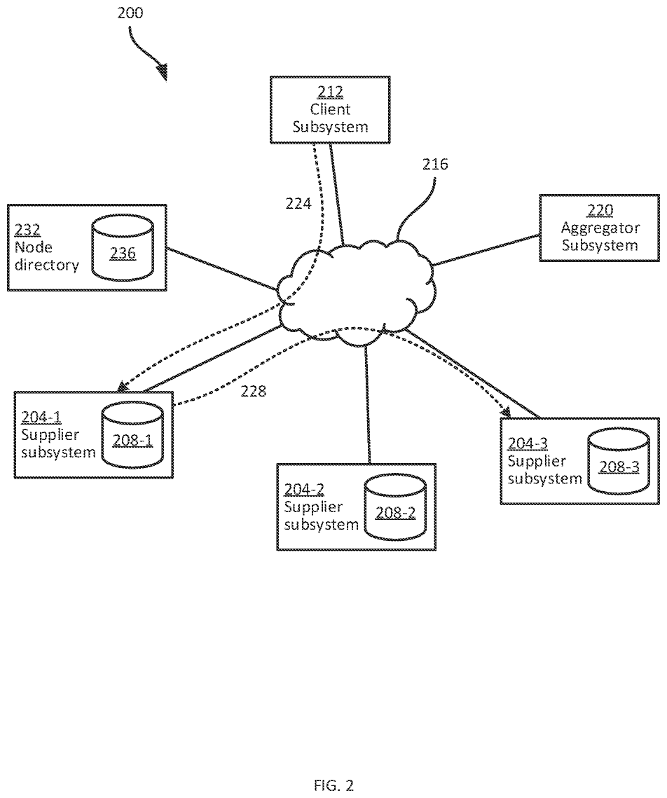

Turning to FIG. 2, a decentralized content distribution system 200 is illustrated, including supplier subsystems 204-1, 204-2, and 204-3 having respective inventory repositories 208-1, 208-2, and 208-3, as well as a client subsystem 212 connected via a network 212. The system 200 may also include an aggregator subsystem 220. The components of the system 200 mentioned above are, with the exception of functionality described below, similar to the corresponding components in FIG. 1. That is, in general, the supplier subsystems 204 store content representing items, and the client subsystem 212 requests such content with a view to purchasing the corresponding items. However, as will be described below in greater detail, the system 200 enables any of the supplier subsystems 204 to receive requests directly from the client subsystem 212, and to forward some or all of such requests to other supplier subsystems 204.

For example, the client subsystem 212 may transmit a request 224 including search parameters directly to the supplier subsystem 204-1 via the network 216. In conventional systems that enable direct contact between client and supplier subsystems, the supplier subsystem 204-1 can return only local content (i.e., from the repository 208-1) to the client subsystem 224. In the system 200, however, the supplier subsystem 204-1 can, in addition to or instead of such local content, retrieve remote content from one or more other supplier subsystems 204, e.g., via a request 228 transmitted directly to the supplier subsystem 204-3. The supplier subsystem 204-3, in turn, may return content to the supplier subsystem 204-1 via the network 216 (i.e., directly, rather than via the aggregator subsystem 220), which may then return both sets of content to the client subsystem 212. In other words, each supplier subsystem 204 (as well as the aggregator 220, when present) can implement a node in the decentralized content distribution system 200. The client subsystem 212 need only interact with a single “entry” node, but is nevertheless enabled to receive content from a wide variety of other nodes.

The system 200 also includes a node directory 232, e.g., an additional computing device connected to the network 216. and storing a set of node profiles in a repository 236. Each node profile can contain various information corresponding to one of the nodes in the system 200 (e.g., one of the supplier subsystems 104), including a network identifier of the relevant node.

Further, as will also be apparent in the discussion below, the additional of further nodes to the system 200 (e.g., additional supplier subsystems 204) may be simplified. For example, adding the identity of a new node to the repository 236 renders that node accessible to any other nodes, thus enabling the distribution of content from the new node with little or no modification to any other node, or to the client subsystem 112.

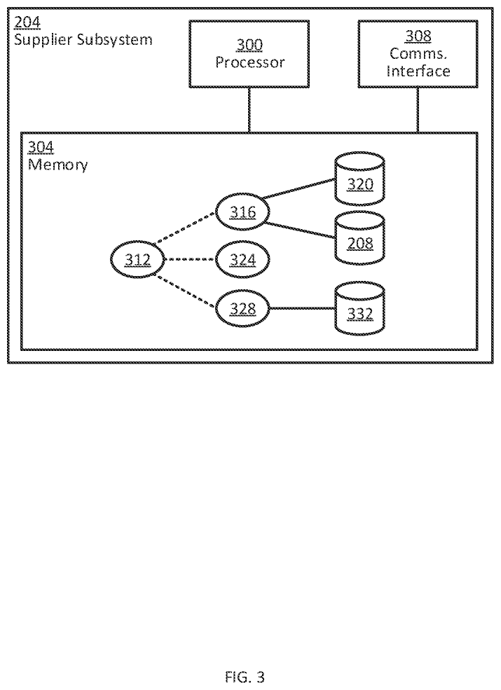

Turning to FIG. 3, certain internal components of a node of the system 200, in the form of a supplier subsystem 204 for illustrative purposes, will be described, before discussing the functionality implemented by those components. Each of the nodes in the system 200 includes the components shown in FIG. 3 and discussed below, although certain nodes may also include additional components. The aggregator subsystem 220, for example, may include components to implement the aggregation functionality mentioned earlier, in addition to those illustrated in FIG. 3.

The supplier subsystem 204 includes at least one processor 300, such as a central processing unit (CPU) or the like. The processor 300 is interconnected with a memory 304, implemented as a suitable non-transitory computer-readable medium, such as a combination of volatile and non-volatile memory components (e.g., any one or more of Random Access Memory (RAM), read only memory (ROM), Electrically Erasable Programmable Read Only Memory (EEPROM), flash memory, magnetic computer storage, and the like). The processor 300 and the memory 304 are generally comprised of one or more integrated circuits (ICs),

The processor 300 is also interconnected with a communications interface 308, which enables the supplier subsystem 204 to communicate with the other computing devices of the system 200 via the network 216 (e.g., the client subsystem 212, and other supplier subsystems 104). The communications interface 208 therefore includes any necessary components (e.g., network interface controllers (NICs), radio units, and the like) to communicate via the network 216. The specific components of the communications interface 308 are selected based on upon the nature of the network 216. The supplier subsystem 204 can also include input and output devices connected to the processor 300, such as keyboards, mice, displays, and the like (not shown).

The components of the supplier subsystem 204 mentioned above can be deployed in a single enclosure, or in a distributed format. In some examples, therefore, the supplier subsystem 204 includes a plurality of processors, either sharing the memory 304 and communications interface 308, or each having distinct associated memories and communications interfaces.

The memory 304 stores a plurality of computer-readable programming instructions, executable by the processor 300 to cause the processor to perform various functions. The applications are therefore said to be configured to perform those functions, meaning that execution of the applications configures the processor 300 (and therefore the supplier subsystem 204 as a whole) to perform such functions. The instructions stored in the memory 304 include several distinct applications, discussed below, in the illustrated example. In other examples, however, these applications can be deployed in other combinations (e.g., including a single application implementing the functionality of each application mentioned below). In further examples, some of the applications stored in the memory 304 can be implemented via distinct computing devices, such that the supplier subsystem 204 includes more than one logical computing device interconnected to form a computing subsystem.

The applications stored in the memory 304 include an orchestrator application 312, configured to handle incoming and outgoing communications with other nodes in the system 200 (via the communications interface 308), and to call the functions implemented by the other applications of the supplier subsystem 204. Those other applications include an offer generator 316 (which may also be referred to as an offer management system, as will be evident to those skilled in the art) coupled with the inventory repository 208, and with an offer storage repository 320. The offer generator 316 is configured to generate offers defining items or sets of items that match search parameters in requests received at the supplier subsystem 204 (whether from the client subsystem 212, or from another supplier subsystem 204). As will be discussed below, the offers generated by the offer generator 316 are stored in the repository 320, and can be based on local content, defined in the repository 208 (i.e., corresponding to items provided by the operator of this particular supplier subsystem 204), on remote content (i.e., corresponding to items provided by a different supplier entity and therefore received from another node in the system 200), or on both local and remote content.

The supplier subsystem 204 further includes a connection manager 324, configured to select other nodes from which to request remote content, e.g., for use in responding to a request received at the supplier subsystem 204. The connection manager 324 can therefore maintain, for example, a set of identifiers and corresponding attributes that are preferred by the operator of the suppliers subsystem 204. The connection manager 324 can also be configured to interact with the node directory 232 to retrieve node identifiers and attributes.

The supplier subsystem 204 also includes an order generator 328 (which can also be referred to as an order management system, as will be evident to those skilled in the art). The order generator 328 is configured to receive requests to book (e.g., purchase, although booking and payment can be technically distinct steps in some systems) items, e.g., corresponding to particular offers stored in the repository 320. The offer generator 328 is configured, in response to booking requests, to initiate downstream processes for delivering the relevant items, and to generate and store order records in an order repository 332.

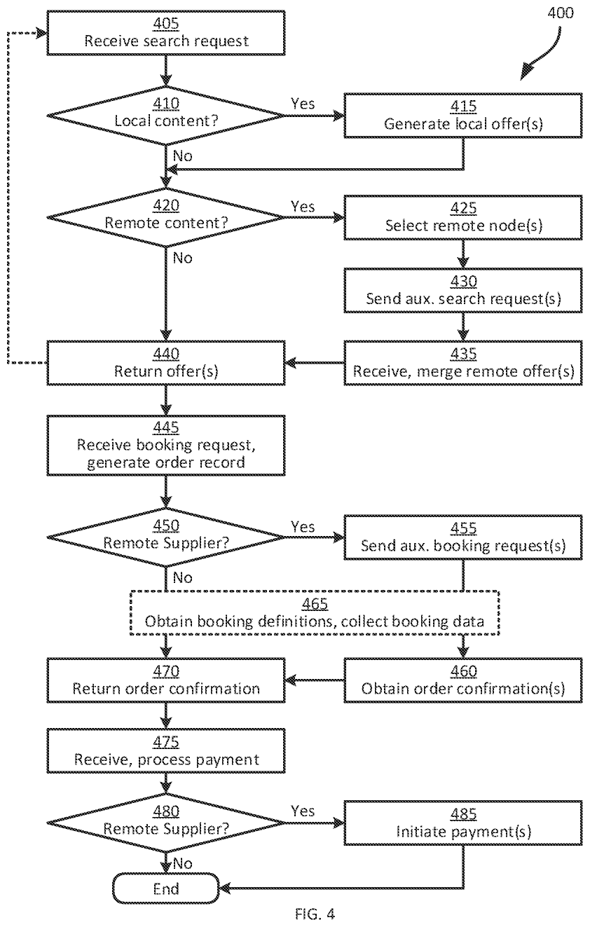

Turning to FIG. 4, a method 400 for decentralized content distribution is illustrated. The method 400 will be described below in conjunction with its performance in the system 200. In particular, each node in the system 200 can perform the method 400 in parallel with performance of the method 400 by other nodes. That is, each of the supplier subsystems 204, as well as the aggregator subsystem 220 (when the aggregator subsystem 220 implements a node in the decentralized content distribution system) can perform distinct instances of the method 400. Such instances may be related temporally, as they may be performed in connection with the same original request from the client subsystem 112.

At block 405, a node in the system 200 is configured to receive a search request. In this illustrative example performance of the method 400, the search request is received, e.g., at the supplier subsystem 204-1, from the client subsystem 112. In other words, this particular search request initiates a shopping process by the client subsystem 112. As will be apparent below, in other performances of the method 400, the request received at block 405 can be received from another node in the system 200.

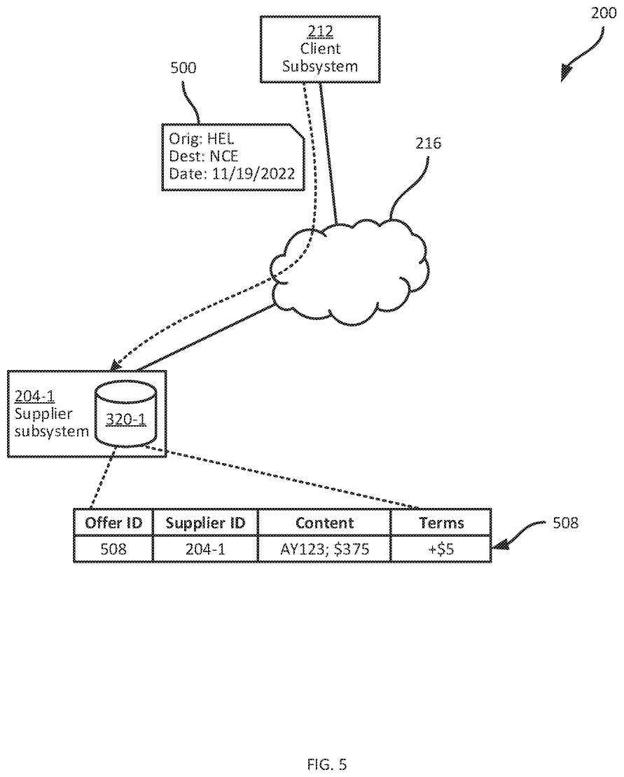

The search request received from the client subsystem 112 at block 405 includes a set of search parameters, defining desired attributes of items such as the travel-related goods and services mentioned previously. For example referring to FIG. 5, a request 500 is shown being transmitted from the client subsystem 212 to the supplier subsystem 204-1, containing search parameters in the form of an origin location (e.g., Helsinki, “HEL”), a destination location (e.g., Nice, “NCE”), and a date of travel (Nov. 19, 2022). As will be apparent, a wide variety of other search parameters can also be included in the request 500, in addition to or instead of those illustrated in FIG. 5. The nature of the search parameters depends on the nature of the items corresponding to the content distributed within the system 200, but has little effect on the technical handling of the messages containing such content.

The supplier subsystem 204-1 receives the request 500 at block 405, via the communications interface 308. Such inbound requests can be directed, for example, to the orchestrator 312 for handling. The supplier subsystem 204-1 is referred to as the entry node in this example, since it is the node at which the initial client request 500 arrived. The entry node is the node of the system 200 that will continue to interact with the client subsystem 112 for the entirety of the transaction initiated by the request 500.

The client subsystem 212 can direct the request 500 to any of the nodes in the system 200. That is, the receipt of the request 500 at the supplier subsystem 204-1 is purely illustrative—the implementation of decentralized content distribution enables any node to act as an entry node, such that the selection of an entry node by the client subsystem 212 can be made according to any logic (e.g., geographic proximity, existing commercial relationship, etc.). Indeed, in some examples, the client subsystem 212 may transmit the request 500 to more than one entry node, thus initiating two independent processes for retrieving content (the results of which may differ from one another depending on which other nodes become involved).

Referring again to FIG. 4, at block 410 the entry node (i.e., the supplier subsystem 204-1 in this example) is configured to determine whether to generate local content corresponding to the request 500, e.g., based on the search parameters in the request 500. That is, the orchestrator 312 can be configured to pass the request 500 to the offer generator 316, and the offer generator 316 is configured to determine, based on the repository 208 and internal content generation logic, whether to generate any offers corresponding to the request 500. The processes performed by the offer generator 316 to generate offers, or to determine that no offers will be generated, are outside the scope of the present discussion. In general, each node in the system 200 can implement a wide variety of such logic, suited to the commercial and/or operational needs of the entity operating that node. The processes performed by the offer generator 316 of one node will often be different from those performed by the offer generator 316 of another node.

When the determination at block 410 is affirmative, the supplier subsystem 204-1 proceeds to block 415, at which the offer generator 316 is configured to generate and store (e.g., in the repository 320) one or more offers containing content corresponding to the request 500. Turning again to FIG. 5, an example offer record 508 is shown as having been generated and stored in the repository 320-1. The offer record 508 includes content defining a flight provided by the operator of the supplier subsystem 204-1, and may therefore include a flight number (e.g., “AY123”), and a price (e.g., $375). The offer record 508 also includes a supplier identifier, which in this case is the identifier “204-1” of the supplier subsystem 204-1 itself, as well as an offer identifier “508”. The offer record 508 can also contain a wide variety of other information, including other attributes of the flight or other item represented by the record 508. In the illustrated example, the record 508 also includes a commercial terms field, representing a commission payable to the upstream entity in the system 200 (i.e., the client subsystem 212 in this example, such as a travel agency).

Returning to FIG. 4, at block 420, after performing block 415 or after a negative determination at block 410, the supplier subsystem 204-1 is configured to determine whether to request remote content from one or more other nodes in the system 200. The determination at block 420 can also be made (as with the determination at block 410) by the offer generator 316. For example, the offer generator 316 can generate any offers (such as the record 508) and also determine whether to request additional offers from other nodes. The determination can be communicated from the offer generator 316 to the orchestrator 312, for example, in the form of search parameters (which can, but do not necessarily, match those in the original request 500) for use in generating outbound requests to other nodes.

As with the offer generation logic, the logic executed by the offer generator 316 to perform block 420 is not particularly limited, and may vary widely between nodes in the system 200. The outcome of the determination at block 420 can be a negative determination, indicating that no further nodes are to be queried, or an affirmative determination, in which case the supplier subsystem 204-1 proceeds to block 425.

At block 425, the orchestrator 312 is configured to call the connection manager 324, e.g., by passing the above-mentioned search parameters received from the offer generator 316 to the connection manager 324. The connection manager 324, in turn, is configured to select one or more remote nodes (i.e., nodes other than the supplier subsystem 204-1 itself) based on the search parameters and/or properties of the other nodes in the system 200 stored locally or retrieved from the node directory 232. The connection manager 324 can store, for example, a list of preferred nodes to which outbound requests are sent from the supplier subsystem 204-1. Profile data can be associated with each node in such a list, and/or can be retrieved from the node directory 232.

Node profile data can define a variety of attributes for each node, including node identifiers such as operator names and/or network identifiers enabling the relevant nodes to be reached over the network 216. The node profile for a given node can also include a public encryption key for that node (e.g., to verify digitally-signed data), content type identifiers indicating what type of content is distributed by the node (e.g., flights, rental vehicle reservations, or the like) and geographic limits to such content distribution. The node profile can also include baseline commercial terms, such as commissions paid to or by the node for various content types. The node profile can also include restrictions on sources for inbound requests (e.g., indicating that the corresponding node only accepts inbound search requests from client subsystems and specifically identified other nodes).

In some examples, the node profile can specify functions enabled by the common messaging protocol employed within the system 200 (e.g., an XML-based messaging protocol such as the New Distribution Capability (NDC) standard or an extension thereof) that are supported by the node. For example, the messaging protocol can define various message flows to search for items, purchase items, cancel purchases, make payments, and the like. Certain nodes, however, may support only a subset of those message flows. The node profile can also contain related data such as payment processing mechanisms supported by the relevant node. The node profile can further include a reputation score corresponding to the relevant node. The reputation score can be maintained by the node directory 232, e.g., based on feedback data received at the node directory 232 from other nodes. The nature of the reputation score is not particularly limited. For example, a reputation score can be decreased if a node defaults on payments to other nodes, if the node returns few or no results in response to search requests from other nodes, and the like. The reputation score can be employed by the connection manager 324 in selecting remote nodes to query for additional content, e.g., by favoring nodes with higher reputation scores.

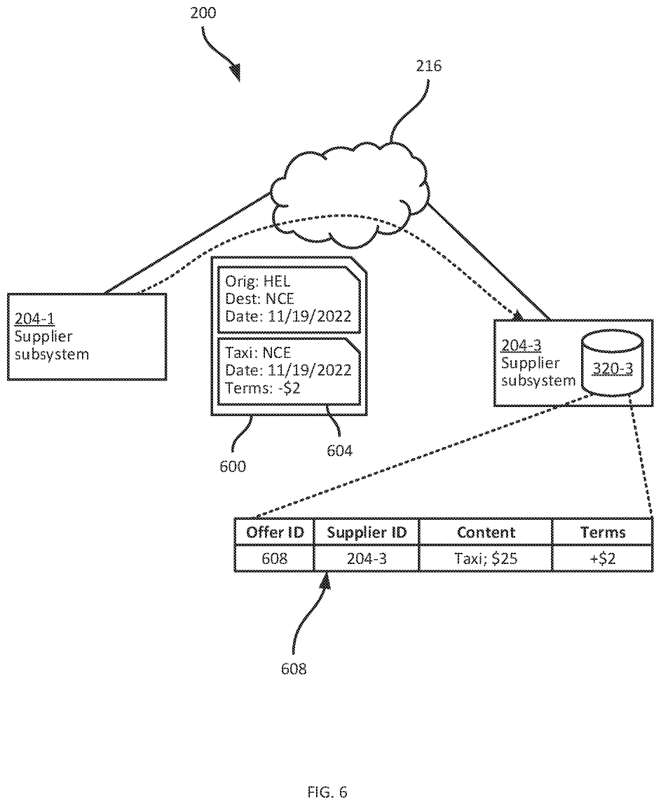

Having completed the selection of remote nodes at block 425, the connection manager 324 is configured to return identifiers of the selected nodes to the orchestrator 312. The orchestrator 312 is then configured, at block 430, to transmit outbound search requests (which may also be referred to as auxiliary search requests) to the selected nodes. Turning to FIG. 6, for example, an outbound search request 600 is illustrated as being transmitted from the supplier subsystem 204-1 to the supplier subsystem 204-3, containing search parameters and commercial terms 604. The search parameters indicate that the supplier subsystem 204-3 is requested to provide offer(s) for taxi services in Nice (i.e., the arrival location specified in the request 500), and that the supplier subsystem 204-1 expects a $2 commission payment from the supplier subsystem 204-3 for any booked taxi service resulting from the request 600.

As shown in FIG. 6, the request 600 also contains the original request 500. More generally, any node generating an outbound request can include the complete chain of previous inbound requests received at other nodes (and ultimately from the client subsystem 212). The provision of a complete chain of requests can enable each node to avoid generating further outbound requests to a node that has already handled a request in the chain, for example. In some examples, the original request, or indeed any earlier requests in the chain, can be omitted.

As will now be apparent, upon receipt of the request 600 (which is an inbound request from the perspective of the supplier subsystem 204-3), the supplier subsystem 204-3 initiates a performance of the method 400, and thus performs blocks 405, 410, and any of 415 to 430 as described above, depending on the decisions resulting from the logic applied to the request 600 by the offer generator 316 of the supplier subsystem 204-3. Referring again to FIG. 6, in the present example the determination at block 410 is affirmative for the supplier subsystem 204-3, and the supplier subsystem 204-3 generates and stores (in the repository 320-3) an offer record 608 defining a taxi reservation at a price of $25. Further, the record 608 indicates a commission payable to the supplier subsystem 204-2, as specified in the request 600. In some examples, the offer record 608 can include an alternative set of commercial terms, e.g., to be accepted or rejected by the supplier subsystem 204-1.

As will be evident, the supplier subsystem 204-3 can also send a further outbound request to yet another node (or set of nodes) in the system 200. In the illustrated example, however, the determination at block 420 for the supplier subsystem 204-3 is negative, and the supplier subsystem 204-3 therefore returns the offer record 608 to the supplier subsystem 204-1, at block 440.

The supplier subsystem 204-1 is therefore configured to receive the offer record 608 (and any other offer records from other queried nodes) at block 435. The supplier subsystem 204-1 can also be configured at block 435 to update the offers generated at block 415 and/or to generate additional offers by merging remote content received at block 435. In other examples, the supplier subsystem 204-1 can simply store the remote content (i.e., the offer record 608 in this example) in the repository 320-1 as an independent offer from the offer record 508.

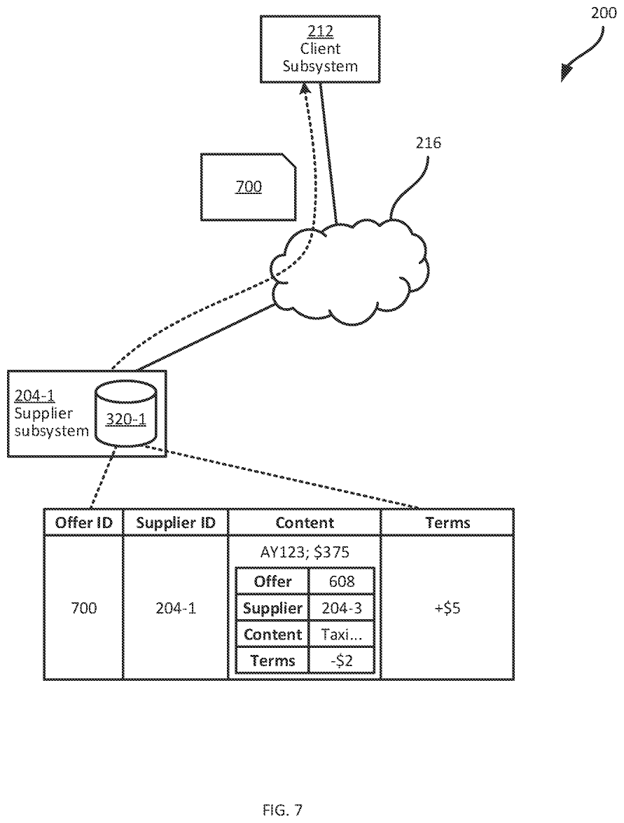

Referring to FIG. 7, an offer record 708 is shown, generated by the supplier subsystem 204-1 at block 435. Specifically, at block 435, the orchestrator 312 receives the offer record 608 from the supplier subsystem 204-3, and passes the offer record 608 to the offer generator 316. The offer generator 316, in turn, processes the offer record 608, the offer record 508, and the original request 500, to determine whether to generate any further offers in addition to, or instead of, the offers defined in the records 508 and 608. As with offer generation at block 410 (i.e., generation of local content), the specific logic applied by the offer generator 316 to determine what offer or sets of offers to assemble from the local and/or remote content obtained via blocks 415 and 435 can vary widely and is outside the scope of the present discussion.

Of particular note, however, when the offer generator 316 does elect to merge local and remote content, the offer generator 316 is configured to logically encapsulate the remote content within the local content for the resulting offer record. For example, FIG. 7 illustrates an updated offer record 700 generated by merging the flight represented by the record 508 and the taxi trip represented by the record 608 (received from the supplier subsystem 204-3). As shown in FIG. 7, the taxi trip is encapsulated within the content field of the offer record 700, such that the content field contains both the flight generated locally, and the taxi trip generated remotely. Further, the encapsulated content (which may also be referred to as subsidiary, or auxiliary, content) includes an identifier of the node at which it was generated (i.e., the supplier subsystem 204-3 in this example), as well as an offer identifier enabling the supplier subsystem 204-3 to retrieve the relevant content from the repository 320-3. The data structure used to achieve such encapsulation need not be exactly as illustrated in FIG. 7. For example, the supplier subsystem 204-1 can store two distinct records representing the flight and the taxi trip, along with data defining a hierarchical link between the two records. The record 508, meanwhile, can be discarded and/or replaced by the record 700 in the repository 320-1.

At block 440, the supplier subsystem 204-1 is configured to return the final set of offers generated at block 435 (or block 415, if no remote content was obtained). As will now be apparent, the meaning of “returning” offers varies depending on the position of the node performing block 440 in a chain of nodes responding to a client request. In the case of the supplier subsystem 204-1, returning offers includes transmitting the offer record 700 to the client subsystem 212, as the supplier subsystem 204-1 is the entry node in this example. In the case of the supplier subsystem 204-3, however, returning offers at block 440 was performed in order to send the record 608 to the supplier subsystem 204-1 (which received the record 608 at its own performance of block 435). More generally, offers are returned at block 440 to whichever node in the system 200 sent the inbound request received at block 405. Thus, in FIG. 7, the supplier subsystem 204-1 is shown transmitting the record 700 to the client subsystem 212.

In some examples, portions of records returned at block 440 can be encrypted or omitted to limit visibility of the contents of those portions within the system 200. For example, each node can be configured to negotiate an encryption key with adjacent nodes in a request chain (e.g., with the node from which an inbound request was received, and with the node(s) to which outbound requests were sent), and to encrypt commercial terms such as the commissions mentioned above with that key. Thus, any node in the system 200 is only enabled to access commercial terms that relate to its own interactions with other nodes.

As will now be apparent, prior to the performance of block 440 by the supplier subsystem 204-1, any number of performances of blocks 405 to 440 can occur at a variety of additional nodes in the system 200. For example, the supplier subsystem 204-3 can, in response to the request 600, not only generate local content but also request further remote content from additional nodes in the system 200. Those additional nodes process such requests as described above, with the effect that the supplier subsystem 204-3 awaits the receipt of remote content at block 435 prior to returning updated offer data to the supplier subsystem 204-1 at block 440 (which in turn awaits the receipt of that remote content at block 435 prior to returning offer data to the client subsystem 212 at block 440).

As shown with a dashed line returning from block 440 to block 405, the supplier subsystem 204-1 (and indeed any supplier subsystem 204) can initiate additional instances of the method 400 in parallel, in response to receiving further requests, whether from client subsystems 212 or other supplier subsystems 204.

Referring again to FIG. 4, at block 445, the supplier subsystem 204-1 is configured to receive a booking request from the client subsystem 212. As will be apparent to those skilled in the art, the client subsystem 212 may present the offers received from the supplier subsystem 204-1 via a user interface, and receive a selection of one or more offers to book (e.g., via an input assembly such as a keyboard, mouse, touch screen, or the like).

In the present example performance of the method 400, for instance, the supplier subsystem 204-1 can receive a request to book the offer record 700 from the client subsystem 212. The booking request may include, for example, an offer identifier (e.g., the identifier “700” of the record 700. In response to the booking request, the entry node (the supplier subsystem 204-1 in this case) is configured to initiate a chain of booking message flows to any other nodes that contributed content to the offer to be booked.

In particular, at block 445 the supplier subsystem 204-1 is configured to generate an order record, for storage in the order repository 332. For example, the orchestrator 312 can retrieve the record 700 from the repository 320, according to the offer identifier in the booking request, and pass the retrieved record 700 to the order generator 328. The order generator 328, in turn, is configured to generate an order record containing the details from the offer record 700. The order record may also contain additional data, and the order generator 328 can also initiate further downstream processes to arrange for the provision of the corresponding item to a customer (e.g., a traveler). Those downstream processes, however, are outside the scope of the present discussion and can be performed according to conventional technologies.

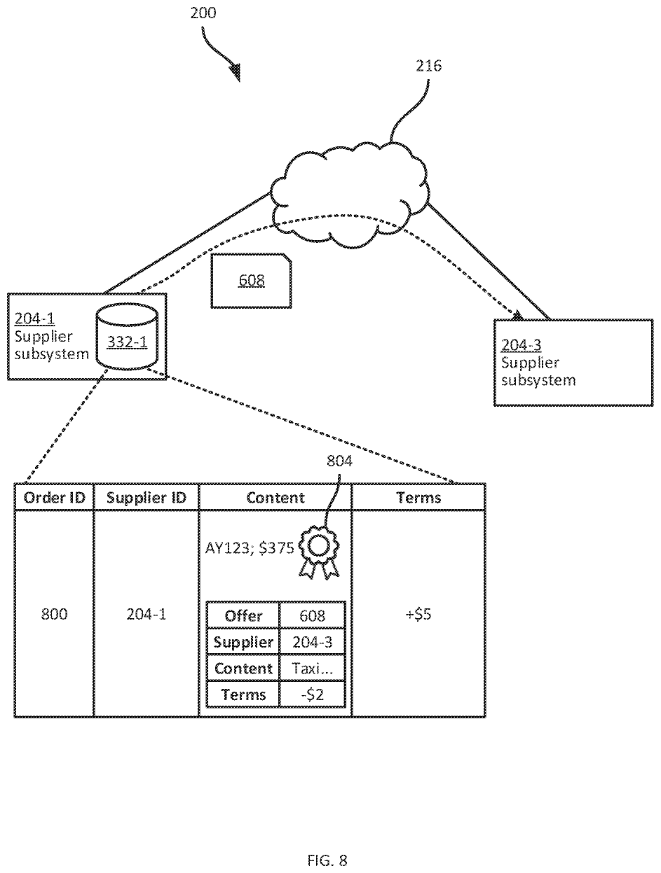

FIG. 8 illustrates an example order record 800 generated following receipt of a booking request from the client subsystem 212. The record 800 can include an order identifier (the string “800” in this example, for simplicity of illustration) distinct from the originating offer identifier, or the order identifier can be identical to the offer identifier. The record 800 includes the content of the originating offer (i.e., from the record 700), and therefore encapsulates any subsidiary content that originated at other nodes, as does the record 700. In addition, the order generator 328 can be configured to digitally sign at least a portion of the order record 800, as indicated by a digital signature 804. In the illustrated example, the local content is digitally signed by the supplier subsystem 204-1. The signing of the content or other portion of the order can be performed, for example, once the above-mentioned downstream processes have been initiated and/or completed.

At block 450 the supplier subsystem 204-1 is configured to determine whether the order includes content with a remote supplier, i.e., subsidiary content. The determination at block 450, in other words, is a determination of whether any of the content in the order record originated at a node other than the supplier subsystem 204-1 itself. In the present example, the determination at block 450 is affirmative, and therefore the supplier subsystem 204-1 proceeds to block 455.

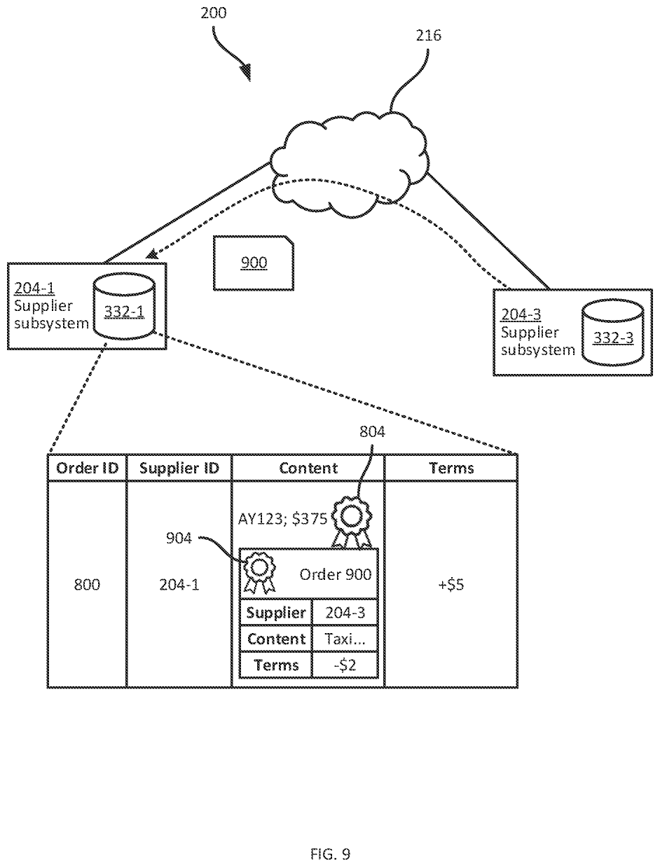

At block 455, the supplier subsystem 204-1 transmits an auxiliary booking request to the corresponding remote node(s) identified in the order record 800. In this example, therefore, as shown in FIG. 8, the supplier subsystem 204-1 can transmit the offer record 608 to the supplier subsystem 204-3. The supplier subsystem 204-3, in turn, performs block 445 upon receipt of the record 608 (which is effectively a booking request), and creates an order record 900 in the repository 332-3, as shown in FIG. 9. The order record 900 includes the same order identifier as the record 800 in this example, but in other examples each node can employ distinct order identifiers, as well as store the order identifiers employed by the other nodes. The supplier subsystem 204-3 can also initiate local downstream processes, and digitally sign (e.g., as shown at 904) the content associated with the supplier subsystem 204-3.

As also shown in FIG. 9, the order record 900 can be returned from the supplier subsystem 204-3 to the supplier subsystem 204-1, which can in turn be configured to update the record 800, e.g., to replace the offer 608 component of the record 800 as shown in FIG. 8 with the signed order component (i.e., including the signature 904) shown in FIG. 9.

At block 450, the supplier subsystem 204-3 determines whether any further subsidiary content is present. That is, the supplier subsystem 204-3 determines whether any content from another node is encapsulated within the content generated by the supplier subsystem 204-3 itself. In this example, the determination is negative, but it will be apparent that this process can repeat for a number of distinct nodes in a chain of content distribution.

Returning to the supplier subsystem 204-1, at block 460 the supplier subsystem 204-1 is configured to obtain order confirmations from any subsidiary nodes (i.e., the supplier subsystem 204-3 in this example). Receipt of an order confirmation can include, for instance, receiving an updated order record in which the subsidiary content is digitally signed by the corresponding node. Thus, at block 460, the supplier subsystem 204-1 can receive the order record 900, and update the order record 800 with the signed content from the order record 900.

In some examples, the booking process involves collecting additional information from the client subsystem 212 (e.g., passport numbers, driver license identifiers, or the like). To enable the collection of such information, the nodes involved in supplying the content in an order record can communicate booking definitions to one another, enabling any entry node to collect relevant booking data for any other node, independently of the content type the entry node itself supplies. For example, an entry node operated by a rental vehicle agency can be enabled to collect complete booking information for a flight (e.g., including a passport number, which a rental car agreement typically would not require) on behalf of a subsidiary node operated by an airline, For example, at block 465, a subsidiary node can transmit a request for booking data to the entry node (or, more broadly, to the next node up in the hierarchy) specifying which information is to be collected from the client subsystem 212. The above requests can be cascaded through multiple nodes, until the entry node collects the requests and transmits a prompt to the client subsystem 212 for the relevant information. Any collected information can then be returned to the subsidiary nodes, enabling those nodes to generate order confirmations for receipt at higher-level nodes via block 460.

At block 470, the supplier subsystem 204-1 is configured to return an order confirmation to the client subsystem 212. As will be evident, the performance of block 470 at the supplier subsystem 204-3 enables the supplier subsystem 204-3 to return an order confirmation to the supplier subsystem 204-1, which receives that confirmation at block 460 as set out earlier. The order confirmation returned to the client subsystem 212 can, for example, include the order number and the order content, optionally with a prompt for payment.

At block 475, the entry node (e.g., the supplier subsystem 204-1) can receive and process a payment for the order. In particular, the supplier subsystem 204-1 processes a payment for the total amount of the order (i.e., the prices associated with every component of content in the order), such that the client subsystem 212 need only submit a single payment. In some examples, prior to processing the payment, the supplier subsystem 204-1 can verify that all the components of the initial offer are present in the order for which the payment is intended, and/or that each of the above components has an expected status (e.g., that inventory for the order is secured, that the booking was successfully confirmed, or the like).

At block 480, the supplier subsystem 204-1 is then configured to determine whether the order involves remote suppliers, as described in connection with block 450. When the determination at block 480 is negative, performance of the method 400 can end. When the determination at block 480 is affirmative, however, as in the present example, the supplier subsystem 204-1 is configured to initiate payments to subsidiary nodes at block 485. Specifically, the supplier subsystem 204-1 is configured to initiate a payment to each immediate subsidiary node (Le., encapsulated at a depth of one in the content field of the order record 800). If the order record includes further subsidiary content obtained from a further subsidiary node (e.g., if the supplier subsystem 204-3 obtained content from the supplier subsystem 204-2), the supplier subsystem 204-1 need not arrange payments for the further subsidiary content. Instead, such payments are handled via distinct performances of blocks 475 to 485 by subsidiary nodes.

As will be apparent from the discussion above, therefore, the system 200 enables decentralized distribution of content, without requiring client subsystems 212 to interact with multiple content suppliers.

The system 200 can also, in some examples, process updates to booked orders, e.g., in the event of flight cancellations or the like. For example, each node having contributed content to an order can maintain a copy of the order, and in response to detecting a disruption or other update to local content, can transmit an indication of the update to the immediate parent node, and any immediate subsidiary nodes. The indication can include a remedial action, e.g., determined by the offer generator 316. The order record can therefore be updated via a process similar to the generation of offers mentioned above, with the update eventually being communicated to the client subsystem 212.

The scope of the claims should not be limited by the embodiments set forth in the above examples, but should be given the broadest interpretation consistent with the description as a whole.

1. A method, comprising:
receiving, at a computing device implementing a first node of a plurality of nodes forming a decentralized content distribution system, an inbound content request from an entry one of the nodes, the inbound content request including inbound search parameters derived from a client request received at the entry node;
selecting, at the computing device, based on the inbound content request and a set of node profiles corresponding to the plurality of nodes, a further one of the nodes;
transmitting an outbound content request to the selected further node, the outbound content request containing outbound search parameters based on the inbound search parameters;
receiving, from the further node, subsidiary content corresponding to the outbound search parameters; and
generating and transmitting, to the entry node, a response to the inbound content request, the response including an offer identifier and at least a portion of the subsidiary content.

2. The method of claim 1, wherein selecting the further node includes retrieving an identifier of the further node from a set of preferred node profiles stored at the computing device.

3. The method of claim 1, wherein selecting the further node includes transmitting a query to a node directory accessible to each of the plurality of nodes and containing a set of node profiles.

4. The method of claim 3, further comprising:
storing a predetermined network identifier corresponding to the central repository; and
retrieving the predetermined network identifier to transmit the query.

5. The method of claim 1, further comprising:
generating local content based on the inbound search parameters;
wherein generating the response includes generating an offer including the subsidiary content encapsulated within the local content.

6. The method of claim 1, wherein the subsidiary content includes further subsidiary content encapsulated therein, received at the further node from an additional one of the plurality of nodes.

7. The method of claim 1, wherein the subsidiary content includes (i) data defining an goods or services supplied by the further node, and (ii) data defining commercial terms between the first node and the further node; and wherein the response omits the data defining the commercial terms.

8. The method of claim 1, further comprising:
receiving, from the entry node, a booking request including the offer identifier;
transmitting a subsidiary booking request to the further node identifying the subsidiary content; receiving a booking confirmation from the further node; and
returning the booking confirmation to the entry node.

9. The method of claim 8, wherein the booking confirmation includes the subsidiary content, digitally signed by the further node.

10. A computing device implementing a first node of a plurality of nodes forming a decentralized content distribution system, comprising:
a memory;
a communications interface; and
a processor configured to:
receive an inbound content request from an entry one of the nodes, the inbound content request including inbound search parameters derived from a client request received at the entry node;
select based on the inbound content request and a set of node profiles corresponding to the plurality of nodes, a further one of the nodes;
transmit an outbound content request to the selected further node, the outbound content request containing outbound search parameters based on the inbound search parameters;
receive, from the further node, subsidiary content corresponding to the outbound search parameters; and
generate and transmitting, to the entry node, a response to the inbound content request, the response including an offer identifier and at least a portion of the subsidiary content.

11. The computing device of claim 10, wherein the processor is configured to select the further node by retrieving an identifier of the further node from a set of preferred node profiles stored at the computing device.

12. The computing device of claim 10, wherein the processor is configured to select the further node by transmitting a query to a node directory accessible to each of the plurality of nodes and containing a set of node profiles.

13. The computing device of claim 12, wherein the memory stores a predetermined network identifier corresponding to the central repository; and
wherein the processor is configured to retrieve the predetermined network identifier to transmit the query.

14. The computing device of claim 10, wherein the processor is further configured to:
generate local content based on the inbound search parameters; and
generate the response by generating an offer including the subsidiary content encapsulated within the local content.

15. The computing device of claim 10, wherein the subsidiary content includes further subsidiary content encapsulated therein, received at the further node from an additional one of the plurality of nodes.

16. The computing device of claim 10, wherein the subsidiary content includes (i) data defining an goods or services supplied by the further node, and (ii) data defining commercial terms between the first node and the further node; and wherein the response omits the data defining the commercial terms.

17. The computing device of claim 10, wherein the processor is further configured to:
receive, from the entry node, a booking request including the offer identifier;
transmit a subsidiary booking request to the further node identifying the subsidiary content; receiving a booking confirmation from the further node; and
return the booking confirmation to the entry node.

18. The computing device of claim 17, wherein the booking confirmation includes the subsidiary content, digitally signed by the further node.
